(19) United States
(12) Patent Application Publication
(10) Pub. No.: US 2010/0098341 A1
(43) Pub. Date: Apr. 22, 2010

(54) IMAGE RECOGNITION DEVICE FOR DISPLAYING MULTIMEDIA DATA

(76) Inventors: Shang-Tzu Ju, Hsinchu City (TW); Ching-Chieh Wang, Yilan County (TW)

Correspondence Address: NORTH AMERICA INTELLECTUAL PROPERTY CORPORATION, P.O. BOX 506, MERRIFIELD, VA, 22116, US

(21) Appl. No.: 12/254,843

(22) Filed: Oct. 21, 2008

(51) Int. Cl. G06K 9/64

(52) U.S. Cl. 382/209

(57) ABSTRACT

An image recognition system, includes: an image capturing device, for multimedia data corresponding to a plurality of parameters respectively; an image recognition device, coupled to the image capturing device and the LUT, for recognizing a captured image and generating a parameter as an input to the LUT; and a first multimedia display device for displaying multimedia data from the LUT that corresponds to the parameter input to the LUT.

### BACKGROUND

The present invention relates to an image recognition system, and more particularly to an image recognition system that generates a plurality of multimedia data corresponding to a plurality of images, respectively.

As mobile phones and handheld devices become more sophisticated while still remaining affordable by the large majority of people, great pains are taken by manufacturers to corner the market through the addition of new technology. In particular, wireless technology and digital cameras have enabled users to communicate with each other interactively.

Instant messaging software such as Microsoft Messenger and Skype can be utilized with webcams to enable a user to see live video of another user. This allows users to see changes in expression and makes the ‘chat’ more personal. Where live video is not available, instant messaging software also offers a wide range of ‘emoticons’ that can be selected by a user for conveying a certain mood or emotion. To select these emoticons, either a table containing all pictures must be accessed, or a shorthand code that is converted by the software must be keyed in. For example, to represent a smile, or ‘happy’ a user must key in a colon followed by a parenthesis, e.g.: +)= [symbol] It can be difficult for a user to memorize all the shorthand codes, and the end picture displayed is not particularly personal. Although live video does not have these disadvantages, it occupies a significant amount of bandwidth, although it only needs to be utilized when showing a change in expression.

### SUMMARY

It is therefore an aim of the present invention to provide a faster method of displaying emoticons on screen that further provides a personal set of pictures, text, or multimedia that can be selected by a user.

An image recognition system according to an exemplary embodiment of the present invention comprises: an image capturing device, for capturing at least an image; a look-up table (LUT) for storing a plurality of multimedia data corresponding to a plurality of parameters respectively; an image recognition device, coupled to the image capturing device and the LUT, for recognizing a captured image and generating a parameter as an input to the LUT; and a first multimedia display device for displaying the multimedia data from the LUT that corresponds to the parameter input to the LUT.

A method for generating multimedia data according to image recognition comprises: capturing at least an image; activating image recognition software to determine if the captured image corresponds to at least a parameter; when the captured image is recognized, a parameter is generated which maps the captured image to output corresponding multimedia data; and displaying the multimedia data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an image recognition system according to an exemplary embodiment of the present invention.

FIG. 2 is a flowchart detailing steps of the method of the image recognition system shown in FIG. 1.

### DETAILED DESCRIPTION

The present invention aims to provide an image recognition system for generating multimedia data that illustrates specific moods or emotions, without requiring a webcam connection or the inputting of large amount of texts. The present invention software can be implemented in any device that has a camera and communication application.

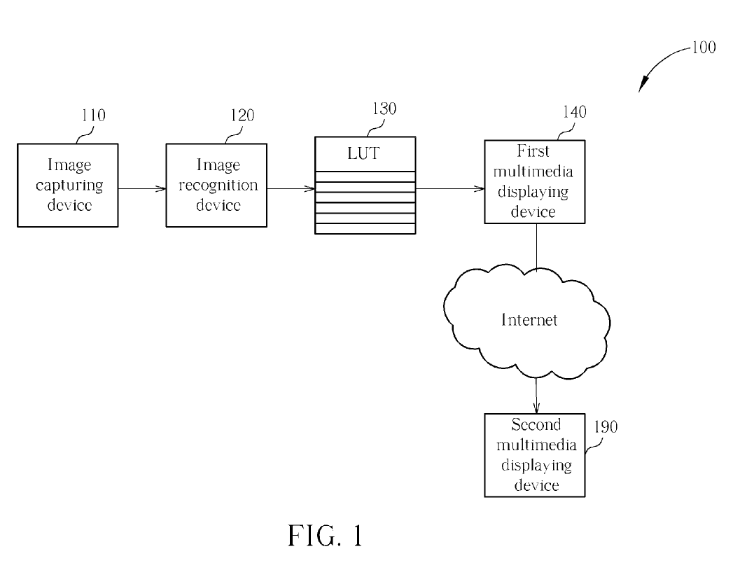

Please refer to FIG. 1. FIG. 1 is a diagram of an exemplary embodiment of the image recognition system 100. The image recognition system 100 comprises an image capturing device 110, such as a camera, an image recognition device 120, a look-up table 130, a first multimedia displaying device 140 and a second multimedia displaying device 190. The diagram shows an Internet connection between the first multimedia displaying device 140 and the second multimedia displaying device 190. Please note that the sending of multimedia data between the first multimedia displaying device 140 and the second multimedia displaying device 190 can be automatic or can be according to a user input.

The look-up table (LUT) 130 is for storing a plurality of multimedia data, each multimedia data corresponding to a particular parameter, which is the output of the image recognition system 100. The user may wish to use a plurality of facial expressions to convey certain emotions. A standard set might include: happy, laughing, tired, angry, sad, bored etc. The user captures his/her facial expression with the image capturing device 110 and the image recognition device 120 maps certain contours of the face that can indicate which expression is being captured. For example, when happy the face will smile, when tired the mouth will be open, when laughing the mouth will be open and the eyes small etc. The operation of image recognition is well known by those skilled in the art and therefore will not be described in great detail in this disclosure. In addition, the image recognition device 120 can be implemented by hardware or software.

Once the facial expression is recognized, a parameter is provided to the LUT for searching a corresponding multimedia in response to the captured facial expression. In some embodiments, the user may be capable of selecting or setting one or a combination of multimedia types as the response of the recognized facial expression. The multimedia data may be in the form of an image icon, picture, music, video clip, text, background color, animation, sound effect, or any combination of the above. Laughing, for example, could produce an emoticon on the first and second multimedia displaying device 140, 190, could generate audio containing the sound of someone laughing, or could play a video clip of someone laughing. The emotion of anger is often associated with the color red, therefore when the user shows a facial expression of anger, the entire screen could turn red, or a visual graphic of flames could be shown on the screen. These descriptions are merely possible examples of multimedia data and are not intended to limit the present invention. The multimedia data is stored in the LUT 130 and can be selected according to the device settings or selected by the user.

In another embodiment, the user first captures a plurality of facial expressions that is either recognized by the image recognition device 120 or predefined by the user. Images representing these facial expressions are stored for later comparison. When utilizing an instant message program, the user utilizes the image capturing device 110 to capture a particular facial expression. The image recognition device 120 then accesses the captured image. If the captured image is recognized as similar to an image previously stored by the user, the LUT 130 is accessed to output a corresponding multimedia data and displayed on the first and second multimedia displaying devices 140, 190. If the image is not recognized by the image recognition device 120, a warning message, containing information indicating that the image has not been recognized, will be displayed on at least one of the first and second multimedia displaying devices 140, 190. In some embodiments, the first and second multimedia displaying devices 140 and 190 can be audio players or multimedia player devices.

Clearly, a user might not always want to convey the facial expression recognized by the system over to the other side. The transmission of the multimedia data between the first multimedia displaying device 140 and the second multimedia displaying device 190 can be enabled according to a user input, rather than automatically sending the multimedia data to the end user.

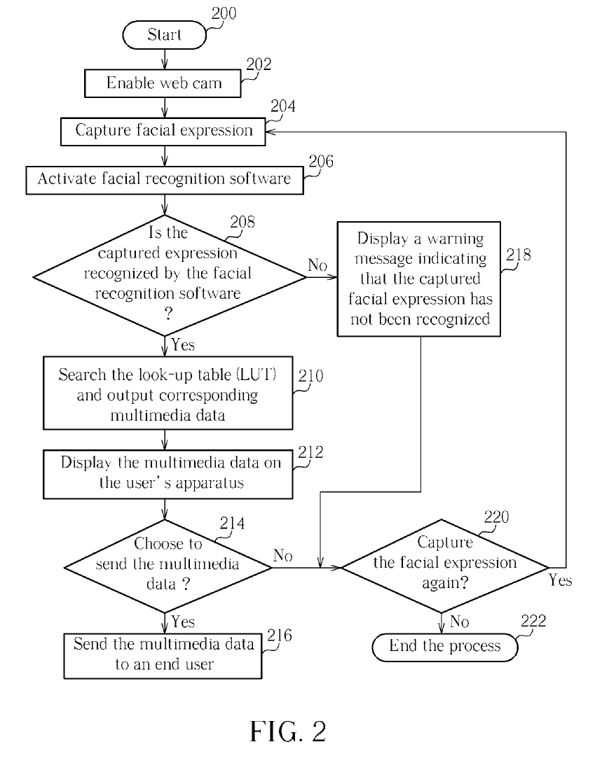

Please refer to FIG. 2. FIG. 2 is a flowchart detailing steps of the method of the image recognition system shown in FIG. 1. The steps are as follows:

The steps are as follows:

Step 200: Start;

Step 202: Enable web cam;

Step 204: Capture facial expression;

Step 206: Activate facial recognition software;

Step 208: Is the captured expression recognized by the facial recognition software? If yes go to Step 210; if no go to Step 218;

Step 210: Search the look-up table (LUT) and output corresponding multimedia data;

Step 212: Display the multimedia data on the user's apparatus;

Step 214: Choose to send the multimedia data? If yes go to Step 216; if no go to Step 220;

Step 216: Send the multimedia data to an end user; go to Step 222;

Step 218: Display a warning message indicating that the captured facial expression has not been recognized;

Step 220: Capture the facial expression again? If yes go to Step 204; if no go to Step 222;

Step 222: End the process.

The present invention provides a fast and bandwidth efficient method for sending multimedia data during instant messaging. The utilization of the LUT enables a user to select personal graphics/audio/video and transmit to a friend in an interesting way. The further implications of such technology could be carried into the realm of sign language, allowing for direct translation between different countries sign language systems.

Those skilled in the art will readily observe that numerous modifications and alterations of the device and method may be made while retaining the teachings of the invention.

What is claimed is:

1. An image recognition system, comprising:
an image capturing device, for capturing at least an image;
a look-up table (LUT) for storing a plurality of multimedia data corresponding to a plurality of parameters respectively;
an image recognition device, coupled to the image capturing device and the LUT, for recognizing a captured image to generate at least a parameter and searching the LUT based on the parameter; and
a first multimedia display device for displaying multimedia data from the LUT that corresponds to the parameter input to the LUT.

2. The image recognition system of claim 1, wherein when a captured image is not recognized by the image recognition device the first multimedia display device displays a message indicating that the captured image is not recognized as a stored image.

3. The image recognition system of claim 1, further comprising:
a second multimedia display device, for displaying the multimedia data corresponding to the multimedia data displayed by the first multimedia display device; and
an Internet connection coupled to the first multimedia display device and the second multimedia display device.

4. The image recognition system of claim 3 wherein the multimedia data is sent from the second multimedia display device to the first multimedia display device through the Internet connection.

5. The image recognition system of claim 3, wherein the Internet connection comprises a wireless connection.

6. The image recognition system of claim 3, wherein the multimedia data is sent to the second multimedia display device through the Internet connection according to a user input.

7. The image recognition system of claim 1, wherein the image recognition device compares the capture image with a plurality of stored images representing different facial expressions, and generates the parameter according to the comparison result.

8. The image recognition system of claim 1, wherein the multimedia data comprises one or a combination of an image icon, picture, music, video clip, text, background color, animation, and sound effect.

9. The image recognition system of claim 1, further comprising:
an Internet connection coupled to the first multimedia display device, wherein the multimedia data is sent to the first multimedia display device through the Internet connection directly.

10. The image recognition system of claim 9, wherein the Internet connection comprises a wireless connection.

11. A method for generating multimedia data corresponding to a captured image, the method comprising:
capturing at least an image;
activating image recognition software to determine if the captured image corresponds to at least a parameter;
when the captured image corresponds to a parameter, mapping the captured image to output multimedia data corresponding to the parameter; and
displaying the multimedia data.

12. The method of claim 11, further comprising:
sending the displayed multimedia data through an Internet connection to an end user.

13. The method of claim 12, wherein the Internet connection is a wireless connection.

14. The method of claim 12, wherein the multimedia data is sent to the second multimedia display device through the Internet connection according to a user input.

15. The method of claim 11, further comprising:
when the captured image does not correspond to a parameter, displaying a message indicating that the captured image is not recognized.

16. The method of claim 11, wherein the image recognition software compares the capture image with a plurality of stored images representing different facial expressions, and generates the parameter according to the comparison.

17. The method of claim 11, wherein the multimedia data comprises one or a combination of image icon, picture, music, video clip, text, background color, animation, and sound effect.
